(19) United States
(12) Patent Application Publication
(10) Pub. No.: US 2026/0249249 A1
(43) Pub. Date: Aug. 27, 2026

(54) DUAL-LAYER HOLLOW FIBRE MEMBRANE

(71) Applicant: DIVIGAS PET LTD, Singapore (SG)

(72) Inventors: Ali Naderi, Port Melbourne (AU); Mohammad Askari, Port Melbourne (AU)

(21) Appl. No.: 19/160,276

(22) PCT Filed: Mar. 4, 2024
(86) PCT No.: PCT/IB2024/052068

§ 371 Date: Aug. 27, 2025

(30) Foreign Application Priority Data
Mar. 3, 2023 (LU) 503578

(51) Int. Cl. B01D 69/08; B01D 53/22; B01D 69/02; B01D 69/12; B01D 71/64; B01D 71/68

(52) U.S. Cl. CPC B01D 69/088; B01D 53/228; B01D 69/02; B01D 69/081; B01D 69/1212; B01D 71/64; B01D 71/641; B01D 71/68; B01D 2256/16; B01D 2257/108; B01D 2257/504; B01D 2325/04

(57) ABSTRACT

A dual-layer hollow fibre membrane for separating gases from a feed gas stream comprises an inner layer of a macromolecular polymer. The macromolecular polymer is a polysulfone. The dual-layer hollow fibre membrane comprises an outer layer made of a combination of polymers. The combination of polymers is selected from at least one of an imide-based polymer and at least one of an imidazole-based polymer. The imide-based polymer is a polyamide-imide, PAI, and the imide-based polymer comprises 5 to 50% by weight of PAI with respect to the outer layer.

### CROSS-REFERENCE TO RELATED APPLICATIONS

This application is a National Phase of PCT Patent Application No. PCT/IB2024/052068 having international filing date of Mar. 4, 2024, which claims the benefit of priority of Luxembourg Patent Application No. LU503578 filed on Mar. 3, 2023. The contents of the above applications are all incorporated by reference as if fully set forth herein in their entirety.

### BACKGROUND OF THE INVENTION

### Field of the Invention

The invention comprises a dual-layer hollow fibre membrane, a method for manufacturing the dual-layer hollow fibre membrane and a method for obtaining a purer gas mixture from a feed gas stream.

### Brief Description of the Related Art

A number of patent applications are known which teach dual-layer hollow fibre membranes. For example, US Patent Application No. US 2016/0375410 A1 teaches a dual-layer hollow fibre membrane for separating and recovering gases including hydrogen and carbon dioxide from feed mixed gas. The dual-layer hollow fibre membrane comprises an inner layer and an outer layer made of the same polymer. The polymer is polybenzimidazole (PBI). US 2016/0375410 A1 further discloses a method for manufacturing the dual-layer hollow fibre membrane. The method for manufacturing the dual-layer hollow fibre membrane comprises a step of preparing a polymer dope comprising PBI. The method further comprises a step of extruding through an orifice of a hollow fibre die the polymer dope and a bore fluid. The bore fluid comprises a mixture of acetonitrile, acetone, methanol, ethanol, or isopropanol with N, N-dimethylacetamide.

Canadian Patent Application No. CA 3 122 213 A1 discloses a dual-layer hollow fibre membrane in gas separation processes. The dual-layer hollow fibre membrane comprises an inner layer and an outer layer made of the same polymer. The polymer is selected from polyimides, co-polyimides, block-copolyimides, polyetherimides and polyamidoimides. The Canadian patent application further discloses a method for manufacturing the dual-layer hollow fibre membrane. The method comprises a step of preparing a polymer dope composition comprising the afore-mentioned polymer and a solvent. The method further comprises a step of co-extruding, through a second orifice of the hollow-fibre die, a composition comprising an amine-based component and a non-solvent.

A dual-layer hollow fibre membrane is disclosed in US Patent Application No. US 2015/0011815 A1. The dual-layer hollow fibre membrane comprises an inner layer made of polyamide-imide and an outer layer made of polyimide. This patent application further discloses a method for obtaining a purer gas mixture from a feed gas mixture. The purer gas mixture comprises substantially carbon dioxide.

US Patent Application No. US 2015/0020685 A1 discloses a dual-layer hollow fibre membrane. The dual-layer hollow fibre membrane comprises an inner layer made of polyether sulfones and an outer layer made of polydimethylsiloxane. US 2015/0020685 A1 further discloses a method for manufacturing the dual-layer hollow fibre membrane. The method comprises a step of coextruding a first composition made of polyether sulfones, a second composition made of polydimethylsiloxane and a third composition made of a bore fluid.

International Patent Application No. WO 2021/018852 A1 teaches a method for obtaining a purer gas mixture comprising hydrogen from a feed gas mixture. The method comprises feeding the feed gas mixture in an inner volume of an electrochemical cell with an anion exchange membrane. The anion exchange membrane comprises a polymer with an inorganic and/or organic filler. The polymer may be polybenzimidazole. The inorganic filler comprises hygroscopic particles, such as nanoparticles of clay, and the organic filler comprises ionomer nanoparticles or fibres.

US Patent Application No. US 2011/192281 A1 discloses a hollow fiber, comprising a lumen, and a polymeric membrane defining the Lumen. The polymeric membrane includes a first polymer and a second polymer. The first polymer is a polybenzimidazole and the second polymer is a polyimide or a polyamide-imide. The hollow fiber further comprises a porous tubular substrate, wherein the outer circumferential surface of the substrate is in contact with the inner circumferential surface of the polymeric membrane. The substrate is formed of a third polymer such as polysulfone, a polyethersulfone. The first polymer is more than more than 20% of the polymer blend by weight.

The dual-layer hollow fibers of US'281 can be produced by co-extrusion of polymeric materials, e.g., via a dry jet wet spinning process (in which an air gap exists between the tip of the spinneret and the coagulation bath). A solution having 10 wt. % p-xylene diamine in methanol is prepared to cross-link the polyimide component of the blend. A solution having 2 wt. % p-xylene dichloride in methanol is used to cross link FBI phase.

Examples 14-17 of US'281 disclose hollow fibers with a Matrimid/PBI blend and polysulfone substrate. The Matrimid:PBI ratio is 1:1 mixture. Matrimid is a commercially available polyimide (PI).

Hosseini et al: “Gas separation membranes developed through integration of polymer blending and dual-layer hollow fiber spinning process for hydrogen and natural gas enrichments,” Journal of Membrane Science, Elsevier BV, NL, vol. 349, no. 1-2, 1 Mar. 2010 (2010 Mar. 1), pages 156-166, XP026874423, ISSN: 0376-7388 discloses a polymer blend composed of Matrimid and poly(benzimidazole) (PSI) prepared and used as the outer layer material for the fabrication of dual-layer hollow fiber membranes. Polysulfone (PSf) was selected as the inner supporting material.

Wang et al.: “Miscibility study of TorlonA® polyamide-imide with MatrimidA® 5218 polyimide and polybenzimidazole”, Polymer, Elsevier, Amsterdam, NL, vol. 48, no. 10, 24 Apr. 2007 (2007 Apr. 24), pages 2901-2909, XP022044129, SSN: 0032-3861, doi: 10.1016/J.POLYMER.2007.03.040 discloses two miscible polymer blend systems, namely, Torlon® 4000T with Matrimid® 5218 and Torlon® 4000T with polybenzimidazole (PBI). Torlon® 4000T is a polyamide (PAI) powder for adhesive applications. Matrimid 5218 is a commercially available polyimide (PI). Wang et al. further discloses an analysis of morphology, a differential scanning calorimetry (DSC) analysis, Fourier transform infrared spectroscopy (FTIR), and dynamic mechanical analysis (DMA) of PAI/PI blends and PI/PBI blends. Wang et al. teaches a study of the two miscible polymer blend systems.

Shao et al: “Comparison of diamino cross-linking in different polyimide solutions and membranes by precipitation observation and gas transport”, Journal of Membrane Science, Elsevier BV, NL, vol. 312, no. 1-2, 5 Jan. 2008 (2008 Jan. 5), pages 174-185, XP022500579, ISSN: 0376-7388, DOI: 10.1016/J.MEMSCI.2007.12.060 discloses membrane preparations of Matrimid® 5218 powder (PI) and 6FDA-durene.

Naderi et al.: “High performance dual-layer hollow fiber membrane of sulfonated polyphenylsulfone/Polybenzimidazole for hydrogen purification”, Journal of Membrane Science, Elsevier BV, NL, vol. 591, 29 Jul. 2019 (2019 Jul. 29), XP085764692, ISSN: 0376-7388, DOI: 10.1016/J.MEMSCI.2019.117292 discloses a dual-layer hollow fiber membrane consisting of a miscible polybenzimidazoles (PBI)/polyphenylsulfone (sPPSU) blend as the selective layer, in other words inner layer, and polysulfone as the supporting layer, in other words outer layer.

Wickramanayake, Shan et al: “Mechanically robust hollow fiber supported ionic liquid membranes for CO2 separation applications”, Journal of Membrane Science 470 (2014): 52-59 shows that Torlon 4000T, i.e., PAI, has a higher mechanical strength than Matrimid 5218, i.e., PI. This mechanical property can be attributed to the higher degree of polymer chain interlocking of PAI than PI.

### SUMMARY OF THE INVENTION

A dual-layer hollow fibre membrane is taught in this disclosure. The dual-layer hollow fibre membrane enables the separation of gases from a feed gas stream. The dual-layer hollow fibre membrane comprises an inner layer of a macromolecular polymer which is used as a mechanical support layer. The macromolecular polymer is made of a polysulfone. In one aspect, the inner layer is made from polysulfone mixed with a first solvent resulting in a first dope. The first solvent can be N-Methyl-2-pyrrolidon (NMP). The polysulfone enables the inner layer to withstand high-temperature and high-pressure operating conditions for gas separation. The concentration of macromolecular polymer solution is below its critical concentration. The structure of the inner layer is a porous structure obtained at the end of the method for manufacturing the dual-layer hollow fibre membrane given a non-solvent induced phase separation method (NIPS) whilst maintaining its mechanical strength. The porous inner layer has substantially low transport resistance for gas separation. The polysulfone provides the dual-layer hollow fibre membrane with excellent mechanical, physical and economic properties.

The dual-layer hollow fibre membrane further comprises an outer layer made of a combination of polymers. The combination of polymers is selected from an imide-based polymer and an imidazole-based polymer. In one aspect, the imide-based polymer can be a polyamide-imide (PAI) and the imidazole-based polymer can be a polybenzimidazole (PBI). In one aspect, the combination of polymers is mixed with a second solvent resulting in a second dope. The second solvent can be dimethylacetamide (DMAc).

It is known that PAI is a more flexible polymer with a higher toughness compared to PBI, which is quite a brittle polymer. However, PAI has a lower chemical and thermal resistance and a lower plasticization pressure against carbon dioxide compared to PBI. PBI has a high chemical and thermal resistance and substantially no plasticization at elevated pressure against carbon dioxide. Making the outer layer of the membrane with a combination of PAI and PBI results in the outer layer having a combination of the properties of PAI and PBI, as PAI and PBI are compatible polymers. This results in the outer layer having a high toughness, a high chemical and thermal resistance and substantially no plasticization at elevated pressure against carbon dioxide.

As noted above, PBI is brittle and renders the manufacture of the membrane hard. Thus, combining PBI with PAI results in the substantially easy manufacture of the membrane and enables the outer layer to have substantially good chemical stability and good separation properties after being crosslinked with α, α′-Dibromo-p-xylene (DBX), and with 1,4-butanediamine (BuDA).

The polysulfone is one of a poly (arylene sulfone) (PAS), poly (bisphenol-A sulfone) (PSF), polyether sulfone (PES), polyphenylenesulfone (PPSU), polysulfone (PSU).

In one aspect, the imide-based polymer of the dual-layer hollow fibre membrane comprises 5 to 20% by weight of PAI with respect to the outer layer and the imidazole-based polymer of the dual-layer hollow fibre membrane comprises 80 to 95% by weight of PBI with respect to the outer layer.

In one aspect, the dual-layer hollow fibre membrane has an internal diameter of at least 100 and at most 1000 μm, but this is not limiting of the invention.

The dual-layer hollow fibre membrane has a permeance for carbon dioxide of at least 0.05 gas permeation unit (GPU) at a temperature between 25° C. and 150° C. In one aspect, the gas permeance of the dual-layer hollow fibre membrane for carbon dioxide is between 3 gas permeation unit (GPU) and 10 GPU at 25° C.

The outer layer of the dual-layer hollow fibre membrane has a thickness of at least 0.5 μm and/or at most 100 μm.

The dual-layer hollow fibre membrane is used for separating hydrogen and carbon dioxide from a feed gas stream.

A method for manufacturing a dual-layer hollow fibre membrane is also described. The method comprises coextruding a bore fluid, a macromolecular polymer mixed with a first solvent, wherein the macromolecular polymer is a polysulfone, and a combination of polymers mixed with a second solvent. The combination of polymers is selected from at least one of an imide-based polymer and at least one of an imidazole-based polymer. The coextrusion of the bore fluid, the macromolecular polymer mixed with the first solvent and the combination of polymers with the second solvent enables the obtention of the dual-layer hollow fibre membrane. The dual-layer hollow fibre membrane is immersed in a first solution in a first vessel. Then, the membrane is immersed in a second solution in a second vessel, enabling a chemical modification of the dual-layer hollow fibre membrane.

In one aspect, the first solution comprises α, α′-Dibromo-p-xylene (DBX) in methanol.

In further aspect, the second solution comprises 1,4-butanediamine (BuDA) in methanol.

A method for separating gases from a feed gas stream to obtain a purer gas stream is also taught. The method comprises feeding the feed gas stream in a membrane module comprising at least one of the dual-layer hollow fibre membrane. The method further comprises increasing the pressure along the membrane module and outputting the purer gas stream.

In one aspect, the dual-layer hollow fibre membrane is used to remove hydrogen from the feed gas stream (i.e., an inlet gas stream) and/or to capture carbon dioxide from the feed gas stream. The purer gas stream is a stream comprising substantially dihydrogen. It has been found that the purity of the hydrogen can reach 99 mol %.

### BRIEF DESCRIPTION OF THE FIGURES

FIG. 1 shows a view of the dual-layer hollow fibre membrane comprising an inner layer and an outer layer. FIGS. 1A to 1E are Field Emission Scanning Electron Microscopy (FESEM) images of the dual-layer hollow fibre membrane. FIGS. 1A, 1B, 1C show cross sections of the outer layer of the dual-layer hollow fibre membrane. FIG. 1D shows of the outer layer of the dual-layer hollow fibre membrane. FIG. 1E shows the inner layer of the dual-layer hollow fibre membrane.

FIG. 2 shows a flow chart describing a method for manufacturing the dual-layer hollow fibre membrane.

FIG. 3 shows a view of an apparatus for manufacturing the dual-layer hollow fibre membrane.

FIG. 4 shows a schematic top view of a triple orifice of a spinneret.

FIG. 5 shows a schematic side view of the triple orifice.

FIG. 6A shows a flow chart describing a method for pure gas separation performance to obtain a behaviour of the dual-layer hollow fibre membrane. FIG. 6B shows a flow chart describing a method to measure the mixed-gas separation performance of the dual-layer hollow fibre membrane.

FIG. 7 shows an example of the triple orifice spinneret.

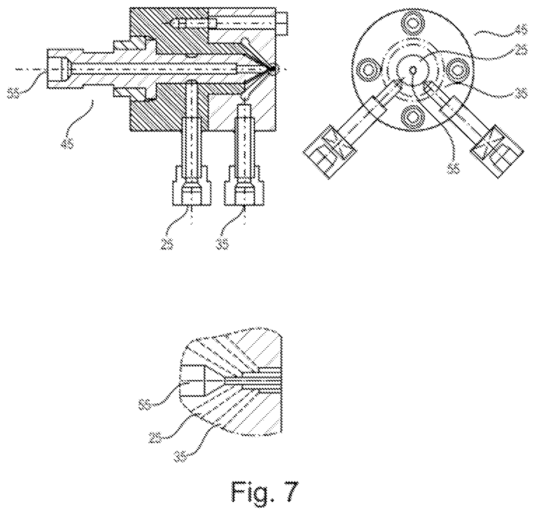

FIG. 8 shows an overview of a pure gas permeation cell. FIG. 8A shows a schematic view of a membrane module of the pure gas permeation cell and FIG. 8B shows the dual-layer hollow fibre membrane when feeding the feed gas stream.

FIG. 9 shows a view of a mixed-gas permeation cell with an exploded view in FIG. 9A.

FIG. 10 and FIG. 11 show images of the dual-layer hollow fibre membrane in a mixed-gas permeation cell.

FIG. 12 shows a Robeson plot as a benchmark for performance comparison of the dual-layer hollow fibre membrane.

### DETAILED DESCRIPTION OF THE INVENTION

The invention will now be described on the basis of the drawings. It will be understood that the embodiments and aspects of the invention described herein are only examples and do not limit the protective scope of the claims in any way. The invention is defined by the claims and their equivalents. It will be understood that features of one aspect or embodiment of the invention can be combined with the feature of a different aspect or aspects and/or embodiments of the invention.

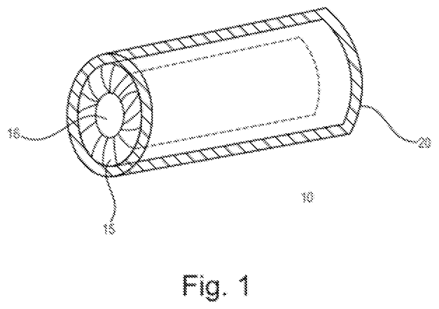

FIG. 1 shows an exemplary view of the dual-layer hollow fibre membrane 10 comprising an inner layer 15 and an outer layer 20. The inner layer 15 is made of a macromolecular polymer. The macromolecular polymer is a polysulfone and the outer layer 20 is made of a combination of polymers. The combination of polymers is selected from any of an imide-based polymer and any of an imidazole-based polymer. The inner layer 15 encloses an inner volume 16 through which gases can flow, as will be explained later.

The polysulfone may be one of a poly (arylene sulfone) (PAS), poly (bisphenol-A sulfone) (PSF), polyether sulfone (PES), polyphenylenesulfone (PPSU) or polysulfone (PSU). The imide-based polymer may be a polyamide-imide (PAI) and the imidazole-based polymer may be a polybenzimidazole (PBI).

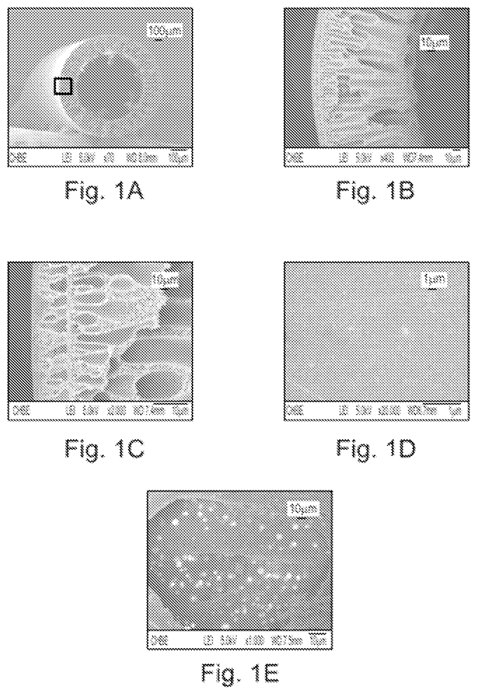

FIG. 2 shows a flow chart describing a method for manufacturing the dual-layer hollow fibre membrane 10 of FIG. 1. In step 100, a first dope 25 is prepared by mixing the macromolecular polymer with a first solvent. The first solvent may be N-Methyl-2-pyrolidone (NMP). Separately, in step 102 a second dope 35 is prepared by mixing the combination of polymers with a second solvent. The second solvent may be N, N-dimethylacetamide (DMAc).

The macromolecular polymer is mixed with the first solvent at a concentration of between 24 wt. % to 29 wt. %. A concentration of 27 wt. % of the macromolecular polymer mixed with the first solvent enables a low transport resistance of gas in the inner layer 15 of the dual-layer hollow fibre membrane 10.

The combination of polymers is mixed with the second solvent at a concentration of at least 22 wt. %. In one aspect, the combination of polymers is mixed with the second solvent at a concentration between 22 wt. % to 26 wt. %. The concentration of the combination of polymers in the second dope 35 is higher than critical concentration of the combination of polymers. The outer layer 20 comprises substantially no defects on the surface. A feed gas stream 90 can be fed from the outer layer 20 of the dual-layer hollow fibre membrane 10 and can pass through the dual-layer hollow fibre membrane 10 by the solution-diffusion mechanism and the molecular sieve mechanism. The feed gas stream 90 does not pass through the dual-layer hollow fibre membrane 10 by the Knudsen diffusion mechanism as the outer layer 20 does not have defects.

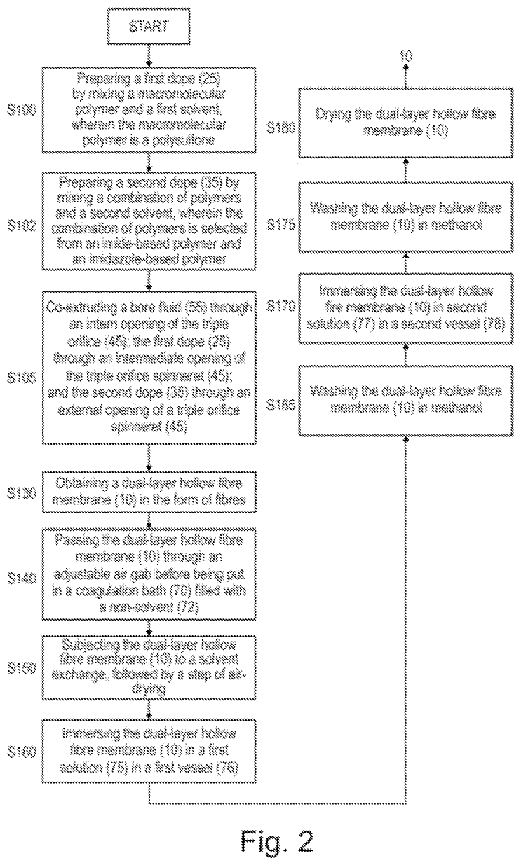

FIG. 3 shows a view of an apparatus 85 for manufacturing the dual-layer hollow fibre membrane. The apparatus 85 comprises a triple orifice spinneret 45, a coagulation bath 70, and a winding roller 80. Inside the coagulation bath 70 is a guide roller 60. The apparatus 85 further comprises a winding roller 80.

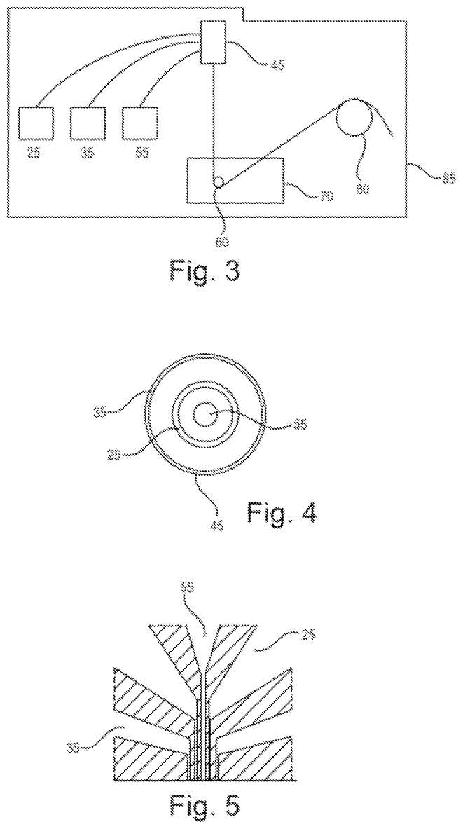

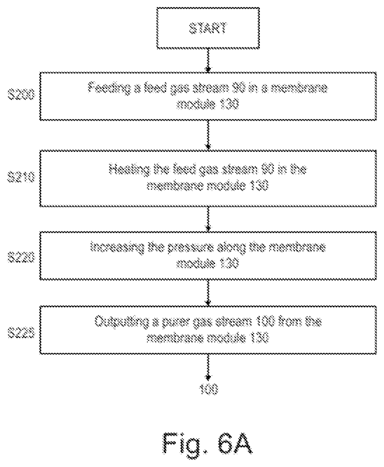

As can be seen in FIG. 4 and FIG. 5, the triple orifice spinneret 45 comprises an external opening 35, an intermediate opening 25 and an internal opening 55. The external opening 35 has an internal diameter between 1 mm and 1.8 mm and an external diameter comprised between 1.2 mm to 2.2 mm. The intermediate opening 25 has, for example, an internal diameter between 0.5 mm and 1.2 mm and an external diameter between 0.8 mm and 1.7 mm. The internal opening 55 has a diameter between 0.4 mm and 0.9 mm.

As can be seen in FIG. 2, in step 105, the second dope 35 is extruded through the external opening of the triple orifice spinneret 45.

In step 105, the first dope 25 is extruded through the intermediate opening of the triple orifice spinneret 45 at the same time as the second dope 35 is extruded through the external opening of the triple orifice spinneret 45.

As can be seen in FIG. 2, in step S105, a bore fluid 55 is extruded through the internal opening of the triple orifice 45 as the same time as the extrusion of the first dope 25 and the second dope 35. The bore fluid 55 can comprise a mixture of a non-solvent and a solvent or can comprise only a non-solvent. The non-solvent can be, for example, water and the solvent can be selected from one of NMP and DMAc. In one example, the bore fluid 55 comprises 90 wt. % of NMP and 10 wt. % of water. The extrusion of the bore fluid 55 through the internal opening of the triple orifice 45 enables the formation of an inner volume 16 in the dual-layer hollow fibre membrane 10.

The coextrusion of the first dope 25, the second dope 35 and the bore fluid 55 is conducted at a temperature between 20° C. to 100° C., for example of 25° C.

As can be seen in FIG. 2, in step S130, the extrusion of the second dope 35, the coextrusion of the first dope 25 and the coextrusion of the bore fluid 55 results in the dual-layer hollow fibre membrane 10 in the form of liquid fibres.

As can be seen in FIG. 2, in step 140, the fibres of the dual-layer hollow fibre membrane 10 pass through an adjustable air gap before being put a coagulation bath 70. The coagulation bath 70 is filled with a non-solvent 72, like water. Putting the fibres of the dual-layer hollow fibre membrane 10 through an adjustable air gap enables to obtain the desired dimension and the desired morphology of the hollow fibre membrane. The length of the air gap depends on the concentrations of the polymers in the first dope 25 and the second dope 35, the take-up speed, the bore fluid flow rate, and the relative humidity. The length of the air gap is optimized to ensure that the polymer chains in the first dope 25 and in the second dope 35 are orientated at the output of the spinneret 45 and also to ensure that the first solvent and the second solvent are pushed out of the first dope 25 and the second dope 35. The air gap is further optimised so that die swell is prevented and so that the formation of macrovoids in the inner layer 15 are prevented. As illustrated in FIG. 1A to 1E, the dual-layer fibre membrane 10 comprises few macrovoids.

The length of the air gap is, for example, between 1 cm to 5 cm, but this is not limiting of the invention. The use of a shorter air gap distance means that it is easier to eliminate the macrovoids. If, on the other hand, the air gap distance is too short (i.e., length<critical length), the die swell induced macrovoids cannot be eliminated by the elongation stretch, and hence the macrovoids form. A short but reasonable air gap distance is still needed to fabricate macrovoid-free hollow fibres. The most likely causes for this discrepancy is that it takes time to remove the effect of die swell, and the take-up induced elongational stress and its effects on membrane morphology require certain distance in the air gap to fully develop.

The coagulation bath 70 is at a temperature between 5 and 70° C. The first solvent and the second solvent are soluble in the non-solvent 72, whereas the polysulfone, the imide-based polymer and the imidazole-based polymer are not soluble in the non-solvent 72. By putting the fibres of the dual-layer hollow fibre membrane 10 in the non-solvent 72, the fibres will precipitate. resulting in the obtention of the dual-layer hollow fibre membrane 10 in a solid substantially porous and asymmetric state. A guide roller 60 guides the dual-layer hollow fibre membrane 10 outside the coagulation bath 70. The dual-layer hollow fibre membrane 10 passes through a winding roller 80 before step S150. The winding roller 80 enables uptake of the dual-layer hollow fibre membrane 10.

As can be seen in FIG. 2, in step S150, the dual-layer hollow fibre membrane 10 is subjected to a solvent exchange. The solvent exchange comprises immersing the dual-layer hollow fibre membrane 10 in a methanol solvent for three times for a period of 30 min each time. The dual-layer hollow fibre membrane 10 is then immersed in a hexane solvent for three times for a period of 30 min each time, followed by a step of air-drying at room temperature for 24 hours. The solvent exchange in step S150 enables fine-tuning the morphology structure of the dual-layer hollow fibre membranes 10 so that the dual-layer hollow fibre membrane 10 has a substantially a high permeability and a high selectivity. The methanol and the hexane have lower surface tension and vapor pressure than water. Putting the fibres in the solvents (i.e., methanol and hexane) that have a lower surface tension and vapor pressure than water results in forming more homogeneous pores in the dual-layer fibre membrane 10. The homogeneous pores are formed when the methanol solvent and the hexane solvent replace water in the dual-layer hollow fibre membrane 10.

As can be seen in FIG. 2, in step S160, the dual-layer hollow fibre membrane 10 is immersed in a first solution 75 in a first vessel 76 for 18 hours at 60° C. The first solution 75 is, for example, a solution of 3 wt. % of α, α′-Dibromo-p-xylene (DBX) in methanol. The dual-layer hollow fibre membrane 10 is then washed in step 165 with methanol. The immersion of the dual-layer hollow fibre membrane 10 in the first solution 75 enables crosslinking of the imidazole-based polymer of the outer layer 20 with the first solution 75.

As can be seen in FIG. 2, in step 170, the dual-layer hollow fibre membrane 10 is immersed in a second solution 77 in a second vessel 78 for one hour at 24° C. The second solution 77 is, for example, a solution of 5% wt. of 1,4-butanediamine (BuDA) in methanol. The immersion the dual-layer hollow fibre membrane 10 in the second solution 77 enables crosslinking of the imide-based polymer of the outer layer 20 with the second solution 77. The dual-layer hollow fibre membrane 10 is then washed in step 175 with methanol.

As can be seen in FIG. 2, in step 180, the dual-layer hollow fibre membrane 10 is dried between 80° C. to 150° C. for example for 3 hours.

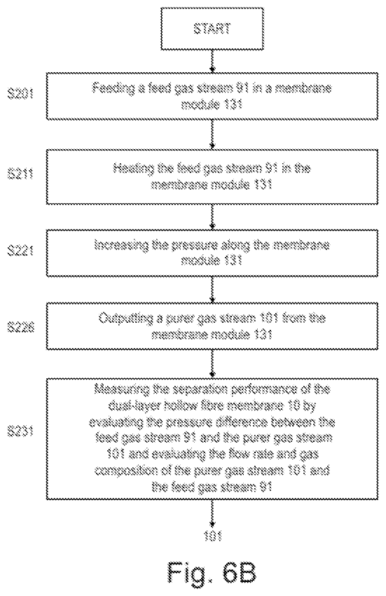

FIG. 6A shows a flow chart describing a method for pure gas separation performance of the dual-layer hollow fibre membrane 10 from a feed gas stream 90. The method can also measure the pure gas separation performance of the dual-layer hollow fibre membrane 10.

A membrane module 130 is a module comprising at least two of the dual-layer hollow fibre membranes 10, for example ten dual-layer hollow fibre membranes. As illustrated in FIG. 6A, the feed gas stream 90 is fed in step 200 in the dual-layer hollow fibre membrane 10 of the membrane module 130. The feed gas stream 90 comprises either of gases such as hydrogen (H₂), carbon dioxide (CO₂), nitrogen (N₂) and methane (CH₄). The feed gas stream 90 is fed to the outside of the dual-layer hollow fibre 10 (this is termed “shell-side” mode).

In step 210, the temperature is increased along the membrane module 130. The temperature along the membrane module 130 is between 25° C. and 150° C.

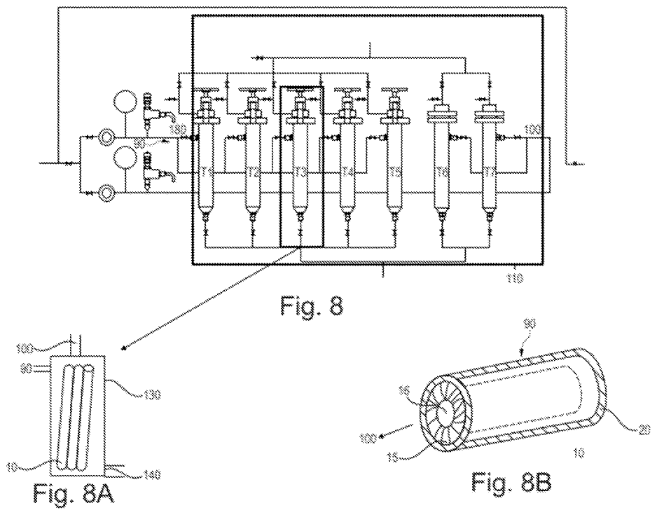

In step 220, the pressure is increased along the membrane module 130. The pressure difference of the feed side (outside) of the hollow fibre membrane 10 and the permeate side, i.e., lumen side, i.e., inside of the hollow fibre membrane 10 is between 2 and 14 bars. A permeate gas stream 100 is output in step S225 from the inner layer 16 of the dual-layer hollow fibre membrane 10 of the module 130 as illustrated in FIG. 8B.

The dual-layer hollow fibre membrane 10 can be used to separate hydrogen gas (dihydrogen) from a feed gas stream 90.

The gas separation performance of the dual-layer hollow fibre membrane 10 can be measured.

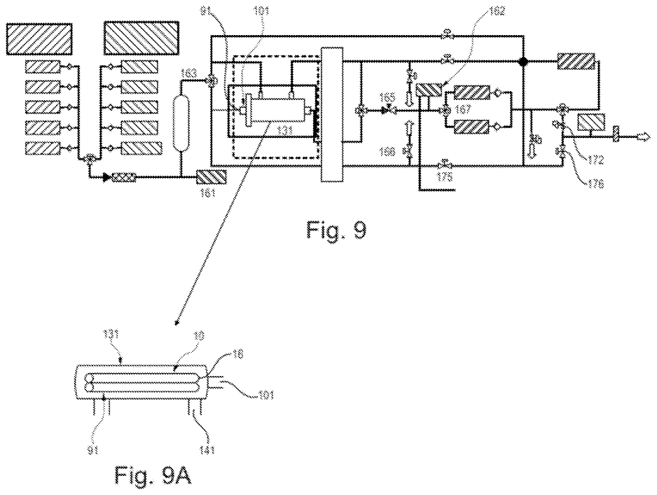

FIG. 6B shows a flow chart describing a method for measuring the mixed-gas separation performance of a dual-layer hollow fibre membrane 10. A membrane module 131 is a module comprising at least two of the dual-layer hollow fibre membranes 10, for example hundred of dual-layer hollow fibre membranes. The method comprises feeding in step S201 a feed gas stream 91 in the membrane module 131 The feed gas stream 91 comprises either two or all of gases such as hydrogen (H₂), carbon dioxide (CO₂), nitrogen (N₂) and methane (CH₄). The feed gas stream 91 is fed to the outside of the dual-layer hollow fibre 10 (this is termed “shell-side” mode). In step 211, the temperature is increased along the membrane module 131. The method further comprises increasing in step S221 the pressure along the membrane module 131 and outputting in step S226 a purer gas mixture 101. The purer gas mixture 101 is a permeate gas stream output in step S226 from the lumen side 16 of the dual-layer hollow fibre membrane 10 of the module 131, as illustrated in FIG. 9A. The method comprises measuring S231 the separation performance of the dual-layer hollow fibre membrane 10. The separation performance is measured by evaluating the difference of the pressure of the feed gas stream 91 at a first pressure sensor 161 and the pressure of the purer gas stream 101 (i.e., atmospheric pressure) at a second pressure sensor 162. The pressure difference is measured at elevated temperature between 25° C. and 150° C. The flow rate and the gas composition of the feed gas stream 91 and the purer gas stream 101 are also measured.

The measuring of the separation performance of the dual-layer hollow fibre membrane 10 comprises determining the gas permeance and the gas selectivity of the dual-layer hollow fibre membrane 10, as will be explained later.

### Examples of Compositions and Process Conditions for the Dual-Layer Hollow Fibre Membrane

The compositions listed in these examples are merely examples of suitable formulations and are not intended to be limiting of the invention (all percentages by weight):

The imide-based polymer of the outer layer 20 is a commercially available polyamide-imide (such as Torlon® PAI) and have been purchased from Solvay Advanced Polymers, Singapore. The imidazole-based polymer of the outer layer 20 is a commercially available polybenzimidazole (such as Celazoles S26 with a molecular weight (Mw) of 27000 g·mol⁻¹ and purchased from PBI Performance Products Inc, USA). The formulation of Celazoles S26 is 72.5 wt. % DMAc, 26 wt. % PBI and 1.5 wt. % lithium chloride (LiCl). The polysulfone of the inner layer 15 was purchased from Solvay Advanced Polymers, Singapore. The PAI and PSF polymers were dried at 110° C. for 24 hours prior to the manufacture of the dual-layer fibre membrane 10. The first solution 75 comprises DBX, 97% purchased from Sigma Aldrich. The second solution 76 comprises BuDA purchased from Sigma Aldrich. DMAc and NMP were purchased from Merck. Hexane and methanol were procured from Merck and used during the solvent exchange, crosslinking, and coating.

Examples of compositions of the second dope 35 are listed below. For each of the compositions 1 to 5, the concentration of the combination of polymers in the second dope 35 is 26 wt. %. The concentration of DMAc in the second dope 35 is 74 wt. %.

Composition 1

| | |
|---|---|
| PBI | 100 |
| PAI | 0 |

Composition 2

| | |
|---|---|
| PBI | 0 |
| PAI | 100 |

Composition 3

| | |
|---|---|
| PBI | 95 |
| PAI | 5 |

Composition 4

| | |
|---|---|
| PBI | 90 |
| PAI | 10 |

Composition 5

| | |
|---|---|
| PBI | 85 |
| PAI | 15 |

Each of the compositions 1 to 5 were prepared S102 by mixing PBI and PAI at the ratios disclosed in the tables as bases the corresponding second dope 35, as can be seen on FIG. 2. The first dope 25 comprising PSF was prepared (step S100) simultaneously by mixing PSF and NMP. The shear viscosities of each of the compositions 1 to 5 and of the first dope 25 with PSF were measured using a cone and plate rheometer (ARES rheometer) at 25° C. with a shear rate of 10 s⁻¹. The measured viscosities enable to calculate the critical polymer concentration of PAI-PBI blend in the second dope 35 and PSF in the first dope 25. The critical polymer concentration measured was 22 wt. % for the PAI-PBI blend in the second dope 35. The concentration of the combination of polymers PAI and PBI (i.e., PAI-PBI blend) in the second dope 35 was chosen above 22 wt. %, so 26 wt. %. A PSF concentration in the first dope 25 of 27 wt. % was chosen. The second dopes 35 were stirred at 60° C. for 24 hours to completely dissolve the PBI, PAI and PBI/PAI in DMAc. The first dope 25 comprising PSF and NMP was stirred at 25° C. for 24 h. Then the first dope 25 and the second dopes 35 were degassed for 24 hours after pouring them into ISCO syringe pumps. The bore fluid comprises 90 wt. % of NMP and 10 wt. % of water.

The dual-layer hollow fibre membrane 10 was fabricated using a dry-jet wet spinning process via extrusion of the first dope 25, extrusion the second dope 35 and extrusion the bore fluid 55 simultaneously (S105) through the triple-orifice spinneret 45, as can be seen on FIG. 2. The triple-orifice spinneret 45 can be seen on FIG. 5. The coagulation bath 70 was tap water. The bore fluid 55 was a mixture of NMP/Water (90/10 wt. %). The flow rate of the first dope 25 is in the range of 2 mL/min to 20 mL/min. The flow rate of the second dope 35 is in the range of 0.3 mL/min to 3 mL/min. The flow rate of the bore fluid 55 is in the range of 0.5 mL/min to 5 mL/min. The air gap is in the range of 1 cm to 5 cm in length. The take-up speed was free fall. The method for manufacturing the dual-layer hollow fibre membrane 10 was carried out at ambient temperature.

As can be seen on FIG. 3, the dual-layer hollow fibre membrane 10 was placed in tap water for two days to remove the residual solvents. The dual-layer hollow fibre membrane 10 was further subjected to solvent exchange comprising a first step of immersing the dual-layer hollow fibre membrane 10 in methanol for three times and 30 min each time, followed by a step of immersing the dual-layer hollow fibre membrane 10 in hexane for three times and 30 min each time.

The following step is air-drying S150 the dual-layer hollow fibre membrane 10 at room temperature for 24 hours. The next step is modifying chemically the dual-layer hollow fibre membrane 10. The dual-layer hollow fibre membrane 10 is immersed S160 in a solution of DBX in Methanol (3 wt. %) for 18 hour at 60° C. The dual-layer hollow fibre membrane 10 was washed S165 with methanol. The dual-layer hollow fibre membrane 10 is immersed S170 in a solution of BuDA in methanol (5 wt. %) for 1 hours at 24° C. followed by washing S175 in methanol and drying (S180) the dual-layer hollow fibre membrane 10 at 120° C. for 3 hours.

The gas separation performance of the dual-layer hollow fibre membrane 10 was measured by using two apparatuses as follows:
a) an apparatus that is a pure gas permeation cell 110, as illustrated in FIGS. 8 and 8A; and
b) an apparatus that is a mixed gas permeation cell 120, as illustrated in FIGS. 9 and 9A.

In the pure gas permeation cell 110, the feed gas stream 90 in the form of pure gas is fed in step S200 (or purged) into the membrane module 130 at a desired pressure (e.g., 7 bar) and at a range of temperatures (e.g., 50° C., 100° C. and 150° C.). The membrane module 130 comprises the dual-layer hollow fibre membrane 10, as explained above. The feed gas stream 90 is a gas selected from H2, N2, CH4, CO2, propane (C3H8) and propene (C3H6). In the figures, Table 1, Table 2 and Table 3, the dual-layer hollow fibre membrane 10 was labelled as Divi-HP-b where b refers to the temperature applied to the dual-layer hollow fibre membrane 10.

In the mixed gas permeation cell 120, the separation performance of the dual-layer hollow fibre membrane 10 is measured by determining permeation of the gas stream, i.e., the feed gas stream 91 and the purer gas stream 101 of the dual-layer hollow fibre membrane 10, as illustrated in FIGS. 9 and 9A. The feed gas stream 91 is a gas mixture and the feed gas stream 91 comprises H2, N2, CH4, and CO2. Determining permeation means that the pressure, the flow rate, and the gas composition of the purer gas stream 101 and the feed gas stream 91 are evaluated in step S231.

The feed gas stream 91 originates from mass flow controller and passes through a first valve 163 before being fed in the membrane module 131. The purer gas stream 101 that is output from the membrane module 131 passes through a second valve 175 and a third valve 176 to measure the purer gas flow rate and the purer gas compositions, respectively. The pressure of the purer gas stream 101 is at atmospheric pressure. Then the purer gas stream 101 passes through the third valve 176 to reach to gas chromatography (GC) for the measurement of the gas compositions.

The permeate gas stream (i.e. purer gas stream 101) and a retentate gas stream 141 are both shown on FIG. 9A. The retentate gas stream 141 is a gas mixture that does not pass through the dual-layer hollow fibre membrane 10.

The pure gas permeation cell 110 comprises seven membrane modules 130, labelled T1 to T7. The membrane module 130 comprises ten dual-layer hollow fibre membranes 10. One example of the membrane module 130 comprising three dual-layer hollow fibre membranes 10 can be seen on FIG. 8A. One example of the dual-layer hollow fibre membrane 10 is shown in FIG. 8B. The membrane module 130 of the pure gas permeation cell 110 has a length of approximately 15 cm, but this is not limiting of the invention. The membrane modules 130 are used for determining the pure gas permeance and the ideal gas pair selectivity of the dual-layer hollow fibre membrane 10. The feed gas stream 90 permeates from the outer layer 20 (feed side) to the inside layer 16 (lumen side) of the dual-layer hollow fibre membrane 10. The pure gas permeance and the ideal gas pair selectivity of the dual-layer hollow fibre membrane 10 were calculated according to Eq. (1) and Eq. (2), respectively.

$$\frac{P}{L} = \frac{273.15 \times {10}^{6}}{T} \times \frac{Q}{π Dl Δ P} \qquad ( 1 )$$

$${α}_{A / B} = \frac{{( \frac{P}{L} )}_{A}}{{( \frac{P}{L} )}_{B}} \qquad ( 2 )$$

where P/L is the gas permeance of the dual-layer hollow fibre membranes 10 in GPU (1 GPU=1×10⁻⁶ cm³ (STP)/cm² s cmHg), Tis the temperature (K), Q is the flux of the purer gas stream 100 (cm³/s), ΔP is the difference of the pressure of the feed gas stream 90 and the pressure of the permeate gas stream 100 (cmHg), D is the outer diameter of dual-layer hollow fibre membrane 10 in centimetres and l is the length of the dual-layer hollow fibre membrane 10 (also measure in centimetres).

$${( \frac{P}{L} )}_{A} and {( \frac{P}{L} )}_{B}$$

are the pure gas permeances of gas A and gas B, respectively. Gas A and gas B are selected from one of H₂, N₂, CH₄, CO₂, C₃H₈ or C₃H₆.

The procedure of the measurement is carried out as follows. The dual-layer hollow fibre membranes 10 are mounted in a module holder and the other end of the dual-layer hollow fibre membranes 10 is sealed (i.e., forms a dead end). The other end is sealed to ensure that the only way for the feed gas stream 90 to pass through the dual-layer hollow fibre membrane 10 is from the feed side to the lumen side. The dual-layer hollow fibre membranes 10 are mounted in the membrane modules 130 of the pure gas permeation cell 110 and fastened. An inlet valve 180 is opened to allow the feed gas stream 90 to go inside the gas permeation cell 110 formed from the dual-layer hollow fibre membranes 10. The flow rate (i.e., permeate flow rate) is measured at the outlet of the dual-layer hollow fibre membranes 10. The membrane module 130 is heated in step S210 so that the feed gas stream 90 is heated. The pressure is increased in step S220 along the membrane module 130. The permeate gas stream 100 is output in step S225 from the membrane module 130.

The results of the pure gas permeance, and the ideal selectivity of the feed gas stream 90 of the dual-layer hollow fibre membrane 10 are set out in the tables below. The results were conducted at 50° C. (Table 1), 100° C. (Table 2) and at 150° C. (Table 3).

TABLE 1

| Membrane | Permeance (GPU) ^{a} | | | | | | Selectivity | | |
|---|---|---|---|---|---|---|---|---|---|
| ID | H [symbol] | N [symbol] | CH [symbol] | CO [symbol] | C [symbol] H [symbol] | C [symbol] H [symbol] | H [symbol] /N [symbol] | H [symbol] /CH [symbol] | H [symbol] /CO [symbol] |
| Divi-HP-50 | 8.7 | 0.061 | 0.058 | 0.38 | 0.021 | 0.013 | 142.6 | 150 | 22.8 |

[symbol]

indicates data missing or illegible when filed

TABLE 2

| Membrane | Permeance (GPU) ^{a} | | | | | | Selectivity | | |
|---|---|---|---|---|---|---|---|---|---|
| Code | H [symbol] | N [symbol] | CH [symbol] | CO [symbol] | C [symbol] H [symbol] | C [symbol] H [symbol] | H [symbol] /N [symbol] | H [symbol] /CH [symbol] | H [symbol] /CO [symbol] |
| Divi-HP-100 | 11 | 0.09 | 0.082 | 0.21 | — | — | 122.2 | 134.2 | 52.4 |

[symbol]

indicates data missing or illegible when filed

TABLE 3

| Membrane | Permeance (GPU) ^{a} | | | | | | Selectivity | | |
|---|---|---|---|---|---|---|---|---|---|
| code | H [symbol] | N [symbol] | CH [symbol] | CO [symbol] | C [symbol] H [symbol] | C [symbol] H [symbol] | H [symbol] /N [symbol] | H [symbol] /CH [symbol] | H [symbol] /CO [symbol] |
| Divi-HP-150 | 1 [symbol] 5 | 0.13 | 0.12 | 0.127 | — | — | 115.4 | 125 | 118.4 |

[symbol]

indicates data missing or illegible when filed

The mixed gas separation performance of the dual-layer hollow fibre membrane 10 is further measured for the feed gas stream 91, comprising a binary mixture of H₂/CO₂ (50:50). The mixed gas separation performance is measured using the mixed gas permeation cell 120 illustrated on FIG. 9 and FIG. 9A.

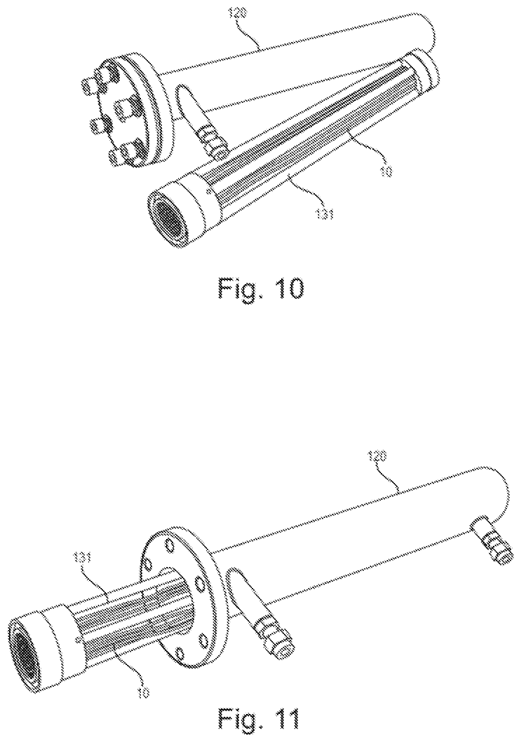

The mixed gas permeation cell 120 comprises a membrane module 131. The membrane module 131 comprises hundred dual-layer hollow fibre membranes 10 with a length of approximately 25 cm, as can be seen on FIG. 10 and FIG. 11. Three same membrane modules named Module 1, Module 2, and Module 3 were manufactured for mixed gas separation tests and to repeat the tests 3 times. The average values of the gas permeances of all three membrane modules Module 1, Module 2, and Module 3 are further measured. It is ensured that the average deviation of the tests was less than 5%.

The feed gas stream 91 is fed at a pressure of 14 bars into the membrane module 131. The tests were performed at 50° C., 100° C. and 150° C. A gas chromatography apparatus was used to analyse the gas composition in the purer gas mixture 101, i.e., the permeate gas mixture as well as the composition of the retentate, i.e., exit gas stream 141.

The mixed gas permeances of the dual-layer hollow fibre membrane 10 were determined by Eqs. (3) and (4) as follows:

$${( \frac{P}{L} )}_{{H}_{2}} = \frac{273.15 \times 1 {0}^{6}}{T} \times \frac{Q \times {y}_{{H}_{2}}}{π Dl ( {P}_{f} \times {x}_{{H}_{2}} - {P}_{p} \times {y}_{{H}_{2}} )} \qquad ( 3 )$$

$${( \frac{P}{L} )}_{{CO}_{2}} = \frac{27315 \times 1 {0}^{6}}{T} \times \frac{Q \times {y}_{{CO}_{2}}}{π Dl ( {P}_{f} \times {x}_{{CO}_{2}} - {P}_{p} \times {y}_{{CO}_{2}} )} \qquad ( 4 )$$

with

$${( \frac{P}{L} )}_{C {O}_{2}} and {( \frac{P}{L} )}_{{H}_{2}}$$

are the CO₂ and H₂ gas permeances, respectively. Q is the flux of the feed gas stream 91 (cm³/s), x and y denote mole fractions in the feed side and permeate side of the dual-layer hollow fibre membrane 10. T is the temperature (K), P_{f} and Pₚ are the pressure at feed side and permeate side of the dual-layer hollow fibre membrane 10, respectively. The selectivity of the feed gas stream 91 comprising H₂/CO₂ mixed gas was calculated by using Eq. (5) as follows:

$${α}_{( {H}_{2} / C {O}_{2} )} = \frac{{y}_{{H}_{2}} / {y}_{{CO}_{2}}}{{x}_{{H}_{2}} / {x}_{{CO}_{2}}} \qquad ( 5 )$$

Table 4 shows gas transport properties of the dual-layer hollow fiber membranes 10 after the step S160 of immersing the dual-layer hollow fibre membranes 10 in a first solution 75 comprising DBX and after the step 170 of immersing the dual-layer hollow fibre membranes 10 in a second solution 77 comprising BuDA (crosslinking steps). The Table 4 shows the effect of the PAI/PBI ratio on gas permeance and separation performance of the dual-layer hollow fibre membranes 10. The Table 4 comprises the denotation Divi-HP-50-c, wherein 50 is the temperature at which the results were conducted, an c is the concentration expressed in % by weight of PAI with respect to the outer layer 20 of the dual-layer hollow fiber membranes 10.

TABLE 4

| | Permeance (GPU) ^{a} | | Selectivity |
|---|---|---|---|
| Sample ID | H₂ | CO₂ | H₂/CO₂ |
| Divi-HP-50-0 | 1.3 | 0.04 | 32.5 |
| Divi-HP-50-5 | 4.4 | 0.16 | 27.5 |
| Divi-HP-50-10 | 8.7 | 0.38 | 22.8 |
| Divi-HP-50-15 | 9.4 | 0.49 | 19 |
| Divi-HP-50-20 | 13.4 | 0.74 | 18 |
| Divi-HP-50-25 | 17.5 | 1.05 | 16.7 |
| Divi-HP-50-50 | 33 | 3.55 | 9.3 |
| Divi-HP-50-75 | 44.8 | 7.86 | 5.7 |
| Divi-HP-50-100 | 63 | 18 | 3.5 |

^{a} 1 GPU = 1 × 10⁻⁶ cm³ (STP)/cm² s cmHg = 7.5005 × 10⁻¹² m s⁻¹ Pa⁻¹. The data were measured at 7 atm and 50° C.

Table 4 shows that incorporating an increased amount of PAI into polymer blend with PBI increases the gas permeances of H₂ and CO₂ but decreases the H₂/CO₂ selectivity due to an increment of chain-chain distance in the dual-layer hollow fiber membranes 10. In other words, the increment of the chain-chain distance decreases the molecular sieving ability of the dual-layer hollow fiber membranes 10 so that the selectivity of the dual-layer hollow fiber membranes 10 decreases.

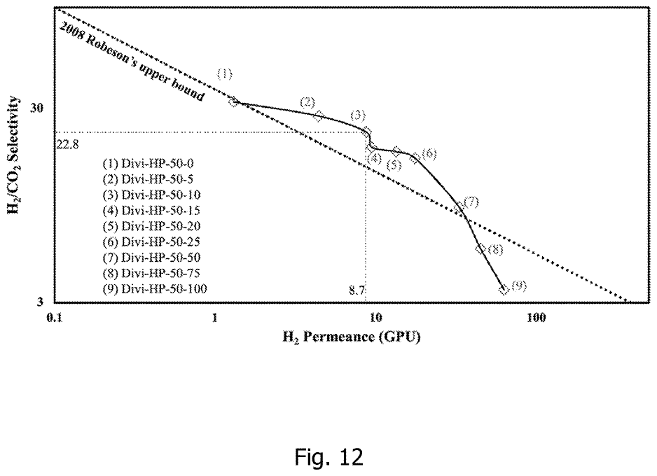

FIG. 12 shows a Robeson plot as a benchmark for performance comparison of Divi-HP-50-c membranes. The Divi-HP-50-c membranes represented in FIG. 12 originate from Table 4. The Robeson plot of FIG. 12 comprises an affine line termed “2008 Robeson's upper bound”. The affine line “2008 Robeson's upper bound” is derived from Lloyd M. Robeson: “The Upper Bound Revisited”, Journal of Membrane Science, Volume 320, Issues 1-2, 2008, pages 390-400, ISSN 0376-7388, https://doi.org/10.1016/j.memsci.2008.04.030.

The 2008 Robeson's upper bound, as explained in “The upper bound revisited,” shows a trade-off between the permeability and the selectivity of a membrane. The selectivity of the membrane tends to decrease as the permeability of the membrane increases, and vice versa. The benchmarking concept disclosed in “The upper bound revisited” is applied to polymeric membranes for various gas pairs. The benchmarking concept has been used in membrane science as a guideline for evaluating the performance of different materials of the membranes. The 2008 Robeson's upper bound is represented graphically as a line in a plot of the permeability against the selectivity. Most membranes are expected to fall below the line. Membranes above this line are considered high-performance membranes. There is a need to engineer the polymeric membranes to obtain a separation performance above the 2008 Robeson's upper bound for any specific gas pairs.

The 2008 Robeson's upper bound as drafted in FIG. 12 is adapted from “The upper bound revisited” assuming a thickness of the outer layer 20 of 1 μm. FIG. 12 shows a comparison of the H₂/CO₂ separation performance of the dual-layer hollow fiber membranes 10 compared to the straight line “2008 Robeson's upper bound”.

The dual dual-layer hollow fiber membranes 10 that are above the “2008 Robeson's upper bound” are considered high-performance membranes, as explained above. Therefore, based on FIG. 12, the dual dual-layer hollow fiber membranes 10 with the point (1), corresponding to Divi-HP-50-0, (2), corresponding to Divi-HP-50-5, (3), corresponding to Divi-HP-50-10, (4), corresponding to Divi-HP-50-15, (5), corresponding to Divi-HP-50-20, (6), corresponding to Divi-HP-50-25, and (7), corresponding to Divi-HP-50-50, have substantially high-performance properties. In other words, the dual dual-layer hollow fiber membranes 10 comprising the imide-based polymer at a concentration between 5 to 50% by weight of PAI with respect to the outer layer (20), have substantially high-performance properties.

It can be seen on FIG. 12 that there is a shoulder, i.e., a step, on the curve at point (3). The dual-layer hollow fiber membranes 10 of point (3) of FIG. 12, corresponding to Divi-HP-50-10 shows the more balanced H₂ permeance/H2/CO₂ selectivity: 8.7 GPU and 22.8 selectivity. Therefore, the dual-layer hollow fiber membranes 10 comprising the imide-based polymer at a concentration of 10 wt % of PAI (i.e., Divi-HP-50-10) is considered to be the best for separating gases from a feed gas stream.

Reference numerals

| | |
|---|---|
| 10 | dual-layer hollow fibre membrane |
| 15 | inner layer |
| 16 | inner volume |
| 20 | outer layer |
| 25 | first dope |
| 35 | second dope |
| 45 | triple orifice spinneret |
| 55 | bore fluid |
| 60 | guide roller |
| 70 | coagulation bath |
| 72 | nonsolvent |
| 75 | first solution |
| 76 | first vessel |
| 77 | second solution |
| 78 | second vessel |
| 80 | winding roller |
| 85 | apparatus |
| 90, 91 | feed gas stream |
| 100, 101 | permeate gas stream |
| 110 | pure gas permeation cell |
| 120 | mixed gas permeation cell |
| 130, 131 | membrane module |
| 140, 141 | retentate gas mixture |
| 161 | first pressure sensor |
| 162 | second pressure sensor |
| 163 | first solenoid valve |
| 166 | second valve |
| 167 | third valve |
| 172 | fourth valve |
| 180 | inlet valve |

1. A dual-layer hollow fibre membrane for separating gases from a feed gas stream (90, 91) comprising:
an inner layer (15) of a macromolecular polymer, wherein the macromolecular polymer is a polysulfone; and
an outer layer (20) made of a combination of polymers, wherein the combination of polymers is selected from at least one of an imide-based polymer and at least one of an imidazole-based polymer; wherein
the imide-based polymer is a polyamide-imide, PAI, and the imide-based polymer comprises 5 to 50% by weight of PAI with respect to the outer layer.

2. The dual-layer hollow fibre membrane of claim 1, wherein the polysulfone is one of a poly (arylene sulfone) (PAS), poly (bisphenol-A sulfone) (PSF), polyether sulfone (PES), polyphenylenesulfone (PPSU), polysulfone (PSU).

3. The dual-layer hollow fibre membrane of claim 1, wherein the imide-based polymer comprises 5 to 20% by weight of PAI with respect to the outer layer, preferably 10% by weight (wt. %) of PAI with respect to the outer layer.

4. The dual-layer hollow fibre membrane of claim 1, wherein the imidazole-based polymer is a polybenzimidazole, PBI.

5. The dual-layer hollow fibre membrane of claim 1, wherein the imidazole-based polymer comprises 80 to 95% by weight of PBI with respect to the outer layer.

6. The dual-layer hollow fibre membrane of claim 1, wherein the dual-layer hollow fibre membrane has an internal diameter of at least 100 and at most 1000 μm.

7. The dual-layer hollow fibre membrane of claim 1, wherein the outer layer has a thickness of at least 0.5 μm and/or at most 100 μm.

8. The dual-layer hollow fibre membrane of claim 1, wherein the outer layer further comprises at least one of 1,4-butanediamine (BuDA), α, α′-Dibromo-p-xylene (DBX) or a combination thereof.

9. The dual-layer hollow fibre membrane of claim 1 for separating hydrogen and carbon dioxide from a feed gas stream (91).

10. A method for manufacturing a dual-layer hollow fibre membrane, the method comprising:
co-extruding a bore fluid, a macromolecular polymer mixed with a first solvent, wherein the macromolecular polymer is a polysulfone and a combination of polymers mixed with a second solvent, wherein the combination of polymers is selected from at least one of an imide-based polymer and at least one of an imidazole-based polymer,
and thereby obtaining a dual-layer hollow fibre membrane;
immersing the dual-layer hollow fibre membrane in a first solution in a first vessel; and
immersing the dual-layer hollow fibre membrane in a second solution in a second vessel; wherein the imide-based polymer of the dual-layer hollow fiber membrane is a polyamide-imide, PAI, and the imide-based polymer comprises 5 to 50% by weight of PAI with respect to an outer layer of the dual-layer hollow fiber membrane.

11. The method of claim 10, wherein bore fluid is a mixture of N-Methyl-2-pyrolidone (NMP) and water.

12. The method of claim 10, wherein the co-extrusions are a dry-jet wet spinning process.

13. The method of claim 10, wherein the polysulfone is one of a poly (arylene sulfone) (PAS), poly (bisphenol-A sulfone) (PSF), polyether sulfone (PES), polyphenylenesulfone (PPSU), polysulfone (PSU).

14. The method of claim 10, wherein the imidazole-based polymer is a polybenzimidazole (PBI).

15. The method of claim 10, wherein the first solution comprises one of a α, α′-Dibromo-p-xylene (DBX), 1,3,5-Tris (bromomethyl)benzene, α, α′-Dibromo-m-xylene, Terephthaloyl chloride, 1,3,5-Benzenetricarbonyl trichloride, Isophthaloyl chloride or a combination thereof in methanol.

16. The method of claim 10, wherein the second solution (77) comprises 1,4-butanediamine (BuDA) in methanol.

17. A method for separating gases from a feed gas stream, the method comprising: feeding a feed gas stream in a membrane module comprising at least one dual-layer hollow fibre membrane, wherein
the dual-layer hollow fibre membrane comprises the inner layer of a macromolecular polymer, wherein the macromolecular polymer is a polysulfone, and an outer layer made of a combination of polymers and wherein the combination of polymers is selected from at least one of an imide-based polymer and at least one of an imidazole-based polymer; wherein
the imide-based polymer is a polyamide-imide, PAI, and the imide-based polymer comprises 5 to 50% by weight of PAI with respect to the outer layer;
increasing the pressure along the membrane module; and
outputting a purer gas mixture.

18. The method of claim 17, wherein the purer gas mixture comprises at least one of hydrogen (H), carbon dioxide (CO₂), methane (CH₄), nitrogen (N₂), propane (C₃H₈), propene (C₃H₆) or a combination thereof.

19. Use of the dual-layer hollow fibre membrane of claim 1 to separate hydrogen or carbon dioxide from the feed gas stream.

20. A method for measuring the separation performance of a dual-layer hollow fibre membrane, the method comprising:
feeding a feed gas stream in a membrane module comprising at least one dual-layer hollow fibre membrane, wherein
the dual-layer hollow fibre membrane comprises an inner layer of a macromolecular polymer, wherein the macromolecular polymer is a polysulfone, and an outer layer made of a combination of polymers and wherein the combination of polymers is selected from at least one of an imide-based polymer and at least one of an imidazole-based polymer; wherein
the imide-based polymer is a polyamide-imide, PAI, and the imide-based polymer comprises 5 to 50% by weight of PAI with respect to the outer layer;
increasing the pressure along the membrane module;
outputting a purer gas mixture; and
measuring the separation performance of the dual-layer hollow fibre membrane by evaluating the pressure difference between the feed gas stream and the permeate gas stream and by measuring the flow rate and the gas composition of the feed gas stream and the permeate gas stream.

21. The method of claim 20, wherein measuring the separation performance of the dual-layer hollow fibre membrane comprises determining the gas permeance and the gas selectivity of the of the dual-layer hollow fibre membrane.
